(19) United States
(12) Patent Application Publication
(10) Pub. No.: US 2009/0214044 A1
(43) Pub. Date: Aug. 27, 2009

(54) DATA ARCHIVING TECHNIQUE FOR ENCRYPTED DATA

(75) Inventor: Junji KINOSHITA, Sunnyvale, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/035,396

(22) Filed: Feb. 21, 2008

(51) Int. Cl. G06F 12/14; H04L 9/12; H04L 9/08

(52) U.S. Cl. 380/283; 380/277; 713/193; 713/165; 711/E12.092

(57) ABSTRACT

Systems and methods for decryption and encryption for data being archived at archive storage systems. The system includes an archive storage coupled to host and client computers and optionally to a network attached storage. The data arriving at the archive storage may contain encrypted data. The encrypted data may be decrypted at the archive storage, at the host computer or at the network attached storage coupled to the archive storage. Indexing information is added to the decrypted data. The data is subsequently re-encrypted before being archived. Encryption key information may be obtained from a key manager or an encryption key may be generated by a host computer or a client computer.

### FIELD OF THE INVENTION

This invention relates generally to computer storage systems and, more particularly, to accessibility of data archived in computer storage systems.

### DESCRIPTION OF THE RELATED ART

Confidential data of companies and organizations may be stored in an employee's portable personal computer or could be attached to an e-mail and sent to others. Theft or loss of the portable computers often causes information leakage accidents. Further, e-mail may be sent to a wrong address by oversight.

Data encryption is often used to prevent information leakage accidents. Encrypted data stored on a stolen computer cannot be read without a proper-encryption key and the recipient of an unintended e-mail cannot open an attached file without a proper encryption key password. Thus, data encryption may mitigate risk of accidental information leakage and some companies encourage their employees to encrypt their data. On the other hand, many companies and organizations have to archive their data for a certain period of time. There may be various reasons for data archiving. Some companies might archive data for potential future litigation. Others might archive data to comply with a government regulation. Organizations usually maintain their data for a long period, resulting in a large volume of data being stored. Retrieving a particular portion of this stored data from within a large amount of stored data in a timely manner presents challenges.

To access archived data effectively, some additional indexing information is usually created for the data when the data is being archived to help the organizations to organize their data and to quickly find the necessary data. Examples of this additional information include meta data, such as a title of a medical image and the like, and search index information.

However, when data reaches the archive storage for archiving purposes, some portion of the data may be already encrypted for security reasons, as described above. Currently, data archiving systems cannot create appropriate meta data or search index information for data that has already been encrypted, because the archiving and/or storage systems do not have access to contents of the encrypted data, e.g. do not have a capability to decrypt such data.

### SUMMARY OF THE INVENTION

The inventive methodology is directed to methods and systems that substantially obviate one or more of the above and other problems associated with conventional techniques for archiving data.

Aspects of the present invention provide systems and method to that use data decryption for encrypted data arriving at an archive storage and subsequent encryption for the archived data in order to properly archive the encrypted data while maintaining accessibility to the archived data.

In accordance with one aspect of the inventive methodology, there is provided a computerized data storage system including an encryption key management module operable to manage a plurality of encryption keys; and an archive storage including one or more interconnect interfaces coupling the archive storage with the encryption key management module and one or more entities. The archive storage receives data including encrypted data from the one or more entities and archives the received data as archived data an in response to receipt of the encrypted data, the archive storage retrieves an encryption key from the encryption key management module, decrypts the received encrypted data using the retrieved encryption key, provides one or more search indices or metadata for decrypted data and re-encrypts the decrypted data before archiving re-encrypted data.

In accordance with another aspect of the inventive methodology, there is provided a computerized data storage system including an encryption key management module for managing a plurality of encryption keys; an archive module operatively coupled with the encryption key management module and one or more entities, the archive module receiving data including encrypted data from the one or more entities and causing the received data to be archived as archived data; and an archive storage coupled with archive module and operable to store the archived data. In response to receipt of the encrypted data, the archive module retrieves an encryption key from the encryption key management module, decrypts the received encrypted data using the retrieved encryption key, provides one or more search indices or metadata for decrypted data and re-encrypts the decrypted data before causing the re-encrypted data to be archived in the archive storage.

In accordance with yet another aspect of the inventive methodology, there is provided a computer-implemented method involving managing multiple encryption keys, receiving data including encrypted data from one or more entities, the encrypted data having been encrypted with one or more of the plurality of multiple encryption keys; in response to receipt of the encrypted data, retrieving an encryption key from the managed plurality of encryption keys, decrypting the received encrypted data using the retrieved encryption key; providing one or more search indices or metadata for decrypted data; re-encrypting the decrypted data; and causing the re-encrypted data to be archived in an archive storage system.

In accordance with yet another aspect of the inventive methodology, there is provided a computer-implemented method for retrieving stored data. The inventive method involves retrieving data; invoking a security module if the data includes encrypted data; if a encryption key is not found within the encrypted data, requesting the encryption key from a key management service module; decrypting the encrypted data using the encryption key; creating search indices or metadata for decrypted data; re-encrypting the data including the decrypted data; and storing re-encrypted data and the search indices or metadata. The inventive method is carried out at a host computer coupled to a storage system and the data is retrieved from the storage system by the host computer, the host computer comprising an archive management functionality. The key management service module is located at the host computer.

In accordance with a further aspect of the inventive methodology, there is provided a computer-implemented method for data storage. The inventive method involves receiving data; invoking a security module if the data includes encrypted data; if a encryption key is not found within the encrypted data, requesting the encryption key from a key management service module; decrypting the encrypted data using the encryption key; creating search indices or metadata for decrypted data; re-encrypting the data including the decrypted data; and storing re-encrypted data and the search indices or metadata. The inventive method is carried out at an archive storage coupled to a host computer and the data is received by the archive storage from the host computer, the host computer including an archive management functionality. The key management service module is located at the host computer.

In accordance with yet further aspect of the inventive methodology, there is provided a computer-readable medium embodying one or more sequences of instructions, which, when executed by one or more processors, causes the one or more processors to perform a method involving: managing multiple encryption keys; receiving data including encrypted data from one or more entities, the encrypted data having been encrypted with one or more of the multiple encryption keys; in response to receipt of the encrypted data, retrieving an encryption key from the managed multiple encryption keys; decrypting the received encrypted data using the retrieved encryption key; providing one or more search indices or metadata for decrypted data; re-encrypting the decrypted data; and causing the re-encrypted data to be archived.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically,

FIG. 1 shows an exemplary data storage system according to aspects of the present invention.

FIG. 2 shows an exemplary architecture for an archive storage according to aspects of the present invention.

FIG. 3 shows an exemplary architecture for a network attached storage.

FIG. 4 shows an exemplary architecture for a host computer adapted for file encryption according to aspects of the present invention.

FIG. 5 shows an exemplary architecture for a host computer adapted for key management according to aspects of the present invention.

FIG. 6 shows an exemplary architecture for a host computer adapted for data archiving according to aspects of the present invention.

FIG. 7 shows an exemplary architecture for a host computer adapted for security management according to aspects of the present invention.

FIG. 8 shows an exemplary architecture for a client computer including a mail client according to aspects of the present invention.

FIG. 9 shows an exemplary architecture for a client computer including a file encryption program according to aspects of the present invention.

FIG. 10 shows an exemplary key management table according to aspects of the invention.

FIG. 11 and FIG. 12 show two exemplary structures for encrypted data according to aspects of the invention.

FIG. 13A, FIG. 13B, FIG. 13C and FIG. 13D show four exemplary methods of encrypting data according to aspects of the present invention.

FIG. 14 shows an exemplary process for archiving encrypted data at a host computer, according to aspects of the invention.

FIG. 15 shows an exemplary process for archiving encrypted data at a network attached storage, according to aspects of the invention.

FIG. 16 shows an exemplary process for reading encrypted data at a host computer, according to aspects of the invention.

FIG. 17 illustrates an exemplary embodiment of a computer platform upon which the inventive system may be implemented.

### DETAILED DESCRIPTION

In the following detailed description, reference will be made to the accompanying drawing(s), in which identical functional elements are designated with such as numerals. The aforementioned accompanying drawings show, by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the from of a software running on a general purpose computer, in the from of a specialized hardware, or combination of software and hardware.

Aspects of the present invention include data archiving techniques for encrypted data. According to aspects of the present invention, a data archive application program and an archive storage communicate with key management systems and retrieve an encryption key for encrypted data before archiving the data, and then create additional data such as meta data or search index information for the data. These additional data may be utilized as search indices for subsequent searching the archived data.

One aspect of the inventive concept includes an archive storage coupled to host and client computers and optionally to a network attached storage. The data arriving at the archive storage may include encrypted data. The encrypted data is decrypted at the archive storage, at the host computer or at the network attached storage coupled to the archive storage. Indexing information is provided for the decrypted data. The data is subsequently re-encrypted before being archived. Encryption key information may be obtained from a key manager on the host computer or an encryption key may be generated by the host computer or the client computer.

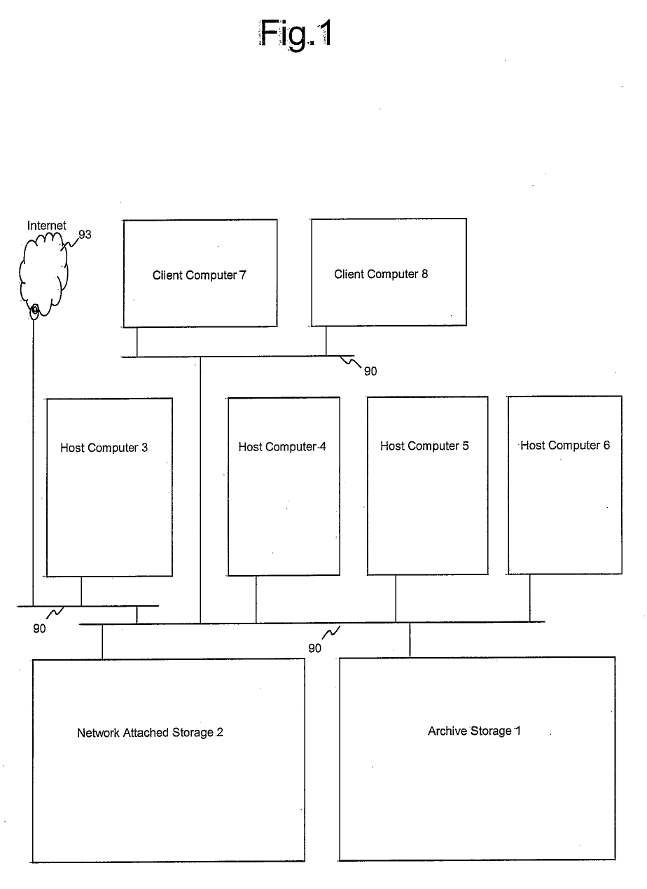

FIG. 1 shows an exemplary data storage system according to aspects of the present invention.

The data storage system shown includes an archive storage 1, one or more network attached storages 2, one or more host computers 3, 4, 5, 6 and one or more client computers 7, 8. A network attached storage is sometimes abbreviated as NAS. These components may be coupled together through a local area network (LAN) 90. Alternatively, a number of different networks may be used to couple the components together.

In the drawing shown, the host computers and the client computers are separated and labeled differently according to their functionalities and intended uses. This is done for ease of description. In actual systems, the same host computer or client computer may be used for multiple purposes and may include all of the functionalities that are being shown as distributed between several host or client computers.

In one exemplary aspect used for providing an exemplary explanation of the operation of the storage system of FIG. 1, the archive storage 1 is used to archive e-mails, attached files and shared data.

The host computer 3 includes a mail server functionality and delivers the e-mails and the attached files. The host computer 3 may use the network attached storage 2 to store the e-mails and the attached files. The host computer 3 may encrypt the attached files according to the security policy of the company or the organization. When the host computer 3 encrypts data, it may store the encryption key information in another host computer 4. The host computer 3 that includes a mail server functionality may be referred to as a mail server.

The client computer 7 sends and receives e-mails and attached files via the host computer 3. The client computer 7 may also encrypt the attached files. When the client computer 7 encrypts data, it may store the encryption key information in host computer 4 as well. The client computer 7 that includes a mail client functionality may be referred to as a mail client.

The client computer 8 also uses the network attached storage to store data, and share the data with other client computers. It may also encrypt data. When the client computer 8 encrypts data, it may store the encryption key information in the host computer 4 as well. The client computer 8 that includes an encryption functionality may be referred to as an encryption client.

The host computer 4 manages the encryption keys that are used by other host computers or by client computers. The host computer 4 that includes an encryption key management functionality may be referred to as a key manager.

The host computer 5 is used for archiving data that is residing on the network attached storage 2, the host computers or the client computers. In this embodiment, the host computer 5 retrieves the data from the network attached storage 2, and stores the retrieved data in the archive storage 1. The host computer 5 that includes an archiving functionality may be referred to as an archive manager.

The host computer 6 is adapted for handling various types of security events that occur in the networks, the client computers, the host computers and the storages areas. The host computer 6 also may provide an administrator with an interface to read archived data. The host computer 6 that includes a security management functionality may be referred to as a security manager.

Again, all of the above host functionalities may be present in the same host computer and all of the above client functionalities may be present in the same client computer.

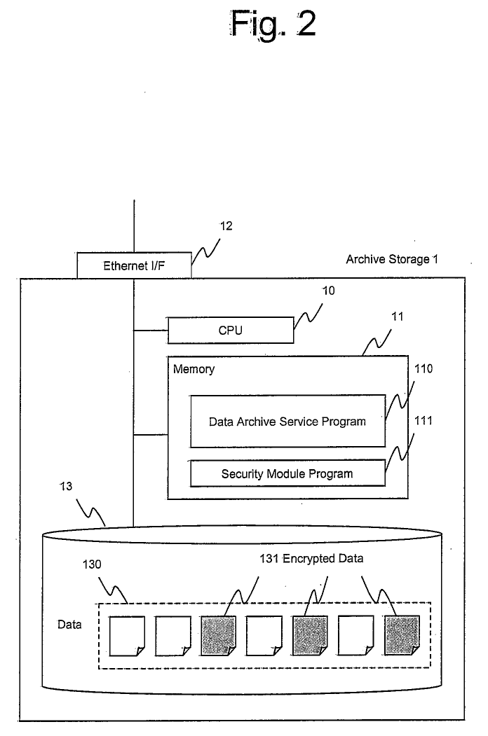

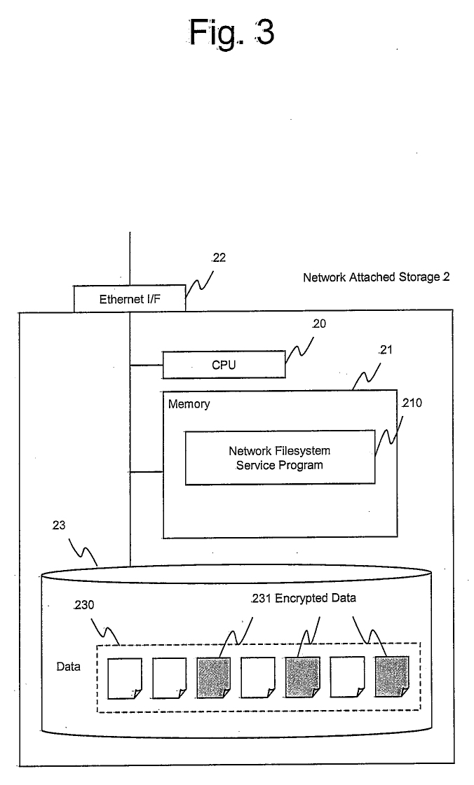

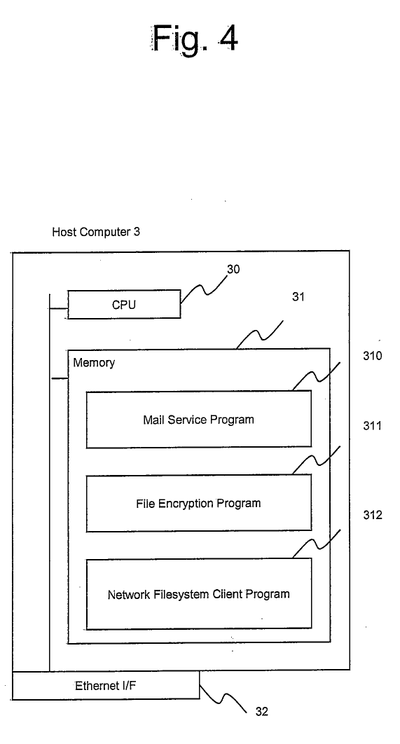

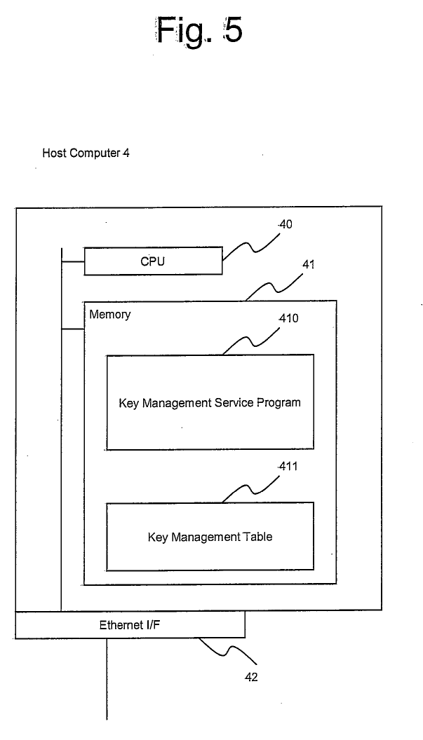

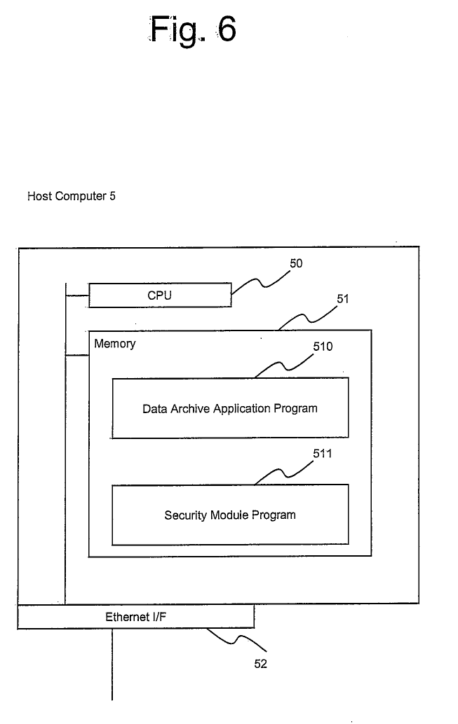

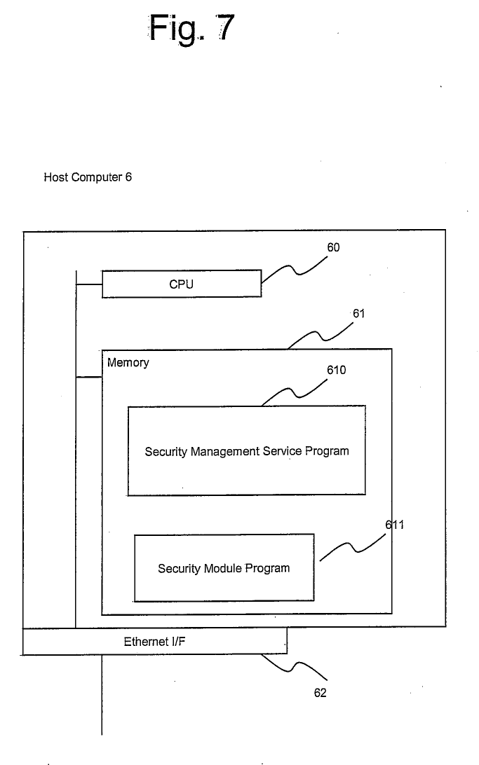

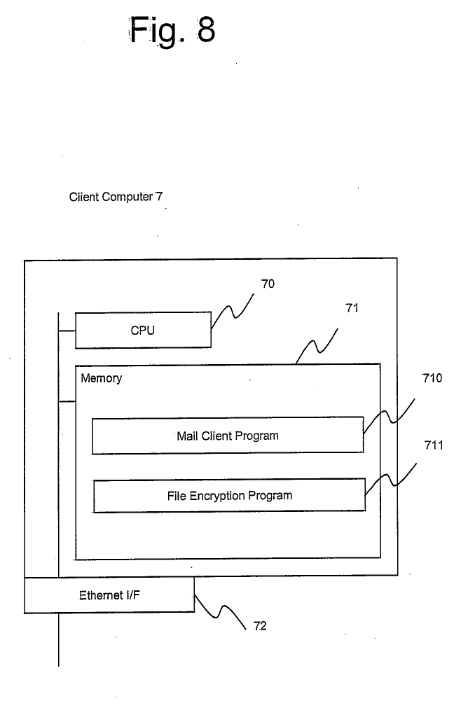

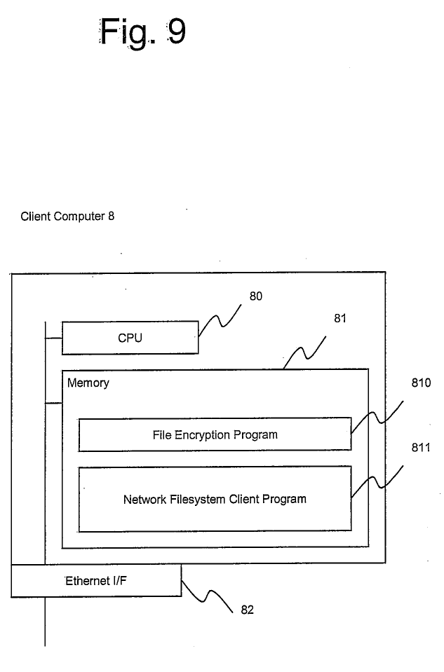

FIG. 2, FIG. 3, FIG. 4, FIG. 5, FIG. 6, FIG. 7, FIG. 8, and FIG. 9 show exemplary architectures for components of FIG. 1. The exemplary architectures show both physical hardware and logical software aspects of the components of the storage system shown in each Figure.

FIG. 2 shows an exemplary architecture for an archive storage according to aspects of the present invention.

One embodiment of the archive storage 1 of FIG. 1 is shown in FIG. 2. The exemplary architecture shows both physical hardware and logical software aspects of the system.

Archive storage systems are used for storing data for a certain period of time for various purposes such as regulatory compliance or in order to remain prepared for any potential litigation. To meet their intended uses, archive storage systems may include data protection functions such as write once read many (WORM) or data retention. Archive storage systems may also create some additional information when they archive the data to help users index the data being archived and so that the users may easily find their intended data from a large amount of the data stored in the archive storage.

To provide a description of the operation of the archive storage of FIG. 2, it is assumed that this storage system is used to archive e-mails, attached files and shared data. Archiving emails, attached files and shared data provide one typical use case scenario of the archive storage and of data archiving. However, the present invention is not limited to use for e-mail archiving and shared file archiving.

The archive storage 1 includes at least one CPU 10, at least one memory 11 and at least one interface 12 that is used for connecting the archive storage 1 to the network 90. The interface may be an Ethernet interface. The archive storage 1 also includes one or more logical volumes 13. The logical volume 13 is comprised of one or more physical storage media such as hard disk drives (HDD), flash memory, optical disks, tape, and the like. The archive storage 1 stores data 130 in the logical volume 13. Some of the data stored may be encrypted data 131.

Software programs are also running on the archive storage 1. The software programs and the information used by the programs are stored in the memory 11 and executed by the CPU 10. The memory 11 includes a data archive service program 110 and a security module program 111.

The data archive service program 110 communicates with a data archive application program 510 that is a part of one of the host computers, such as the archive manager 5 shown in FIG. 6. The security module program 111 communicates with a key management service program 410 that is part of one of the host computers, such as the key manager 5 shown in FIG. 5, as well as a security management service program 610 that is part of one of host computers, such as the security manager 6 shown in FIG. 7.

The data archive service program 110 provides interfaces for storing data in the archive storage 1. For example the data archive application program 510, shown in FIG. 6, stores data in the archive storage 1 using the interface provided by the data archive service program 110. The interface may be a proprietary interface or one of the available network file mechanisms such as network filesystem (NFS) and common internet filesystem (CIFS). The data archive service program 110 also creates additional information such as meta data or search index information when it receives the data. These search indices are used for finding particular portions of the data from among a large volume of archived or stored data. If the data that is received is encrypted, the interface invokes the security module program 111 to decrypt the data.

The security module program 111 may be invoked when the data archive service program 110 receives data from the data archive application program 510 and stores the data, if the data that is received is encrypted. Alternatively, the data archive service program 110 may asynchronously find out encrypted data from the stored data and then invoke the security module program 111. The security module program 111 receives a proper encryption key from the key management service program 410, shown in FIG. 5, to handle the encrypted data. The security module program 111 decrypts the data so that the data archive service program 110 may create appropriate additional information for the data. After the data archive service program 110 creates additional information, the security module program 111 may re-encrypt the data according to the policy set forth by the organization that owns the data. If there is no encryption key that allows the security module program 111 to properly handle the encrypted data, the security module program 111 may send a notification to the security management service program 610, shown in FIG. 7. When the security module program 111 communicates with the key management service program 410 or with the security management service program 610, these programs may use a proprietary mechanism or a standardized mechanism. Their traffic may be protected using some authentication, authorization and in-flight encryption mechanism.

FIG. 3 shows an exemplary architecture for a network attached storage according to aspects of the present invention.

One embodiment of the network attached storage 2 of FIG. 1 is shown in FIG. 3. The exemplary architecture shows both physical hardware and logical software aspects of the system.

Network attached storages are aimed at storing data via networks. Some may store their data in the NAS for the purpose of sharing the data. Some may use the data for the purpose of data backup or data archiving. The network attached storage 2 of FIG. 3 is described in the context of being used to store e-mails, attached files and shared data while it is not limited to such uses.

The network attached storage 2 includes at least one CPU 20, at least one memory 21 and at least one interface 22 that is used for connecting the network attached storage to the network 90. The interface may be an Ethernet interface. The network attached storage also includes one or more logical volumes 23. The logical volume 23 includes a plurality of one or more physical storage media such as HDDs, flash memory, optical disk, tape, and the like. The network attached storage 2 stores data 230 in the logical volume 23. Some of the stored data 230 may be encrypted data 231.

A network filesystem service program 210 is stored on the memory 21 and is in communication with a mail service program 310 of one of the host computers shown in FIG. 4. The software programs running on network attached storage 2 and the information used by these programs are stored in the memory 21. The CPU 20 executes these programs. The network filesystem service program 210 provides an interface for storing data in the network attached storage 2. In the exemplary embodiment shown, the mail service program 310 stores e-mails and attached files in the network attached storage 2 using the interface provided by network filesystem service program 110. The client computer 8 also stores data in the network attached storage 2. The interface may be a network file mechanism such as NFS and CIFS.

FIG. 4 shows an exemplary architecture for a host computer adapted for file encryption according to aspects of the present invention.

One embodiment of the host computer 3 of FIG. 1 is shown in FIG. 4. The exemplary architecture shows both physical hardware and logical software aspects of the system.

It is noted that the host computers 3, 4, 5, 6 shown in FIGS. 4, 5, 6 and 7 are shown as having different structures and including different software only for ease of description. The same host computer may include some or all of these capabilities and functionalities. All of the host computers shown include at least one CPU 30, 40, 50, 60 and at least one memory 31, 41, 51, 61 and they are coupled to the network 90 using a network interface 32, 42, 52, 62. The programs and information required for running them are stored in the memory and executed by the CPU. The memories of the host computers shown in FIGS. 4, 5, 6 and 7 are shown as including different programs and tables for ease of description. One host computer may include some or all of the programs and functionalities that are shown as divided between the host computers.

The memory 31 of the host computer 3 includes the mail service program 310, a file encryption program 311 and a network filesystem client program 312.

The mail service program 310 delivers e-mails and attached files to the client computers such as the mail client 7.

If the attached files are not encrypted, the file encryption program 311 may encrypt the attached files before the mail service program 310 sends them out. The file encryption program 311 may encrypt contents of e-mails as well. When the file encryption program 311 encrypts an email or an attached file, it communicates with the key management service program 410 regarding the encryption. In this embodiment, the file encryption program 311 receives an encryption key from the key management service program 410, or generates an encryption key and registers this key on the key management service program 410. Various types of encryption keys may be used. When the file encryption program 311 communicates with the key management service program 410 or with the security management service program 610, a proprietary mechanism or a standardized mechanism may be used. Further, traffic between these programs may be protected using some form of authentication, authorization and in-flight encryption mechanism.

The network filesystem client program 312 provides the capability to store data in the network attached storage 2. In the exemplary embodiment shown, the host computer 3 stores e-mails and attached files in the network attached storage 2 using the network filesystem client program 312.

FIG. 5 shows an exemplary architecture for a host computer adapted for key management according to aspects of the present invention.

One embodiment of the host computer 4 of FIG. 1 is shown in FIG. 5. The exemplary architecture shows both physical hardware and logical software aspects of the system.

The memory 41 of the host computer 4 includes the key management service program 410 and the key management table 411.

The key management service program 410 provides users and other software with a centralized encryption key management capability. It may receive a key request from another software or user, and generates a unique and random key. Alternatively, the key management service program 410 may receive an encryption key itself that is generated by another software or user. When it generates or receives an encryption key, the key management service program 410 assigns a unique identification information to each encryption key, so that users and other software programs are able to find the proper encryption key at a later date. Various types of encryption keys may be used.

The key management table 411 holds the encryption key value and identification information of each encryption key. The two types of keys included in the key management table are described in further detail below.

FIG. 6 shows an exemplary architecture for a host computer adapted for data archiving according to aspects of the present invention.

One embodiment of the host computer 5 of FIG. 1 is shown in FIG. 6. The exemplary architecture shows both physical hardware and logical software aspects of the system.

The memory 51 of the host computer 5 includes a data archive application program 510 and a security module program 511.

The data archive application program 510 retrieves data from the network attached storage 2 and stores the data in the archive storage 1. While retrieving and storing the data, the data archive application program 510 may also create additional information for the data as meta data according to the security policy of the organization. These search indices, that may include meta data, are used for finding particular portions of the data from among a large volume of archived or stored data. If the data is encrypted, the data archive application program 510 may not be able to create the appropriate meta data for the encrypted data. In that case, it invokes the security module program 511 to decrypt the data and creates proper meta data or other search indices.

The security module program 511 is used when the data archive application program 510 tries to archive the data. The data archive application program may invoke the security module program 511 if the data is encrypted. The security module program 511 communicates with the key management service program 410 and receives an encryption key from the key management service program 410. The security module program 511 decrypts the data so that the data archive application program 510 may create appropriate additional information for the data. After the data archive application program 510 creates the additional information, the security module program 511 may re-encrypt the data according to the security policy of the owner of the data. If there are no encryption keys that allow the security module program 511 to properly handle the encrypted data, the security module program 511 may send a notification to the security management service program 610 of the host computer 6. When the security module program 511 communicates with the key management service program 410 or with the security management service program 610, these programs may use a proprietary mechanism or a standardized mechanism. Traffic between the programs may be protected using some form authentication, authorization and in-flight encryption mechanism.

FIG. 7 shows an exemplary architecture for a host computer adapted for security management according to aspects of the present invention.

One embodiment of the host computer 6 of FIG. 1 is shown in FIG. 7. The exemplary architecture shows both physical hardware and logical software aspects of the system.

The memory 61 of the host computer 6 includes the security management service program 610 and the security module program 611.

The security management service program 610 receives notification when certain types of security related events occur in the organization environment. In this embodiment, the data archive application program 510 of the host computer 5 and the data archive service program 110 of the archive storage may send notifications to security management service program 610 when they find data that may be encrypted by unknown encryption keys. The security management service program 610 may receive those notifications using proprietary or standard mechanisms such as syslog or SNMP. It also may provide a user interface to an administrator so that the administrator may check the security events. In the exemplary embodiment shown, the security management service program 610 provides a user interface to retrieve archived data from the archive storage 1 and to show the data to an administrator. The administrator may review the archived data or search the necessary data using this interface. If the archived data is encrypted, the security management service program 610 cannot provide the administrator with archived data in the appropriate form. In that case, the security management service program invokes the security module program 611 to decrypt the data before presenting it to the administrator.

The security module program 611 is invoked when the security management service program 610 attempts to read the archived data, if the data is encrypted. The security module program 611 communicates with the key management service program 410 and receives an encryption key from the key management service program 410. If there no encryption key is available that allows the security module program 611 to properly handle the encrypted data, the security module program 611 may send a notification to the security management service program 610. When the security module program 611 and the key management service program 410 communicate, they may use a proprietary mechanism or a standardized mechanism. Their traffic may be protected using some authentication, authorization and in-flight encryption mechanism.

FIG. 8 shows an exemplary architecture for a client computer including a mail client according to aspects of the present invention.

One embodiment of the client computer 8 of FIG. 1 is shown in FIG. 8. The exemplary architecture shows both physical hardware and logical software aspects of the system.

Both of the client computers shown include at least one CPU 70, 80 and at least one memory 71, 81 and they are coupled to the network 90 using a network interface 72, 82. The programs and information required for running them are stored in the memory and executed by the CPU. The memories of the client computers shown in FIGS. 8 and 9 are shown as including different programs for ease of description of the two different functionalities assigned to these computers. One client computer may include all of the programs and functionalities that are shown as divided between the client computers.

The memory 71 of the client computer 7 includes a mail client program 710 and a file encryption program 711. The mail client program 710 communicates with the mail service program 310 and sends or receives e-mails and attached files.

The file encryption program 711 may be invoked by the mail client program 710 and may encrypt the attached files before the mail client program 710 sends them out if the attached files are not encrypted according to a user's intention or his organization's security policy. It may encrypt contents of e-mails as well. When the file encryption program 711 encrypts an email or an attached file, it communicates with the key management service program 410 regarding the encryption. In one embodiment, the file encryption program 711 receives an encryption key from the key management service program 410, or generates an encryption key and registers this key on the key management service program 410. Various types of encryption keys may be used. When the file encryption program 711 communicates with the key management service program 410, a proprietary mechanism or a standardized mechanism may be used. Further, traffic between these programs may be protected using some form of authentication, authorization and in-flight encryption mechanism.

FIG. 9 shows an exemplary architecture for a client computer including a file encryption program according to aspects of the present invention.

The exemplary architecture shows both physical hardware and logical software aspects of the system.

The memory 81 of the client computer 8 includes a file encryption program 810, and a network filesystem client program 811.

The file encryption program 810 may be used to encrypt files. When the file encryption program encrypts files, it communicates with the key management service program 410 and receives an encryption key from the key management service program 410, or generates an encryption key and registers it on the key management service program 410.

The file encryption program 810 may be invoked by another program or embedded into operating system or filesystem of the client computer 8. When the file encryption module 810 and the key management service program 410 or the security management service program 610, communicate together, they may use a proprietary mechanism or a standardized mechanism. Their traffic may be protected using some form of authentication, authorization and in-flight encryption mechanism.

The network filesystem client program 811 provides a capability to store data in the network attached storage 2. The client computer 8 stores files, including encrypted files, in the network attached storage 2 using the network filesystem mechanism such as NFS or CIFS provided by the network filesystem client program 811 and the network filesystem service program 210.

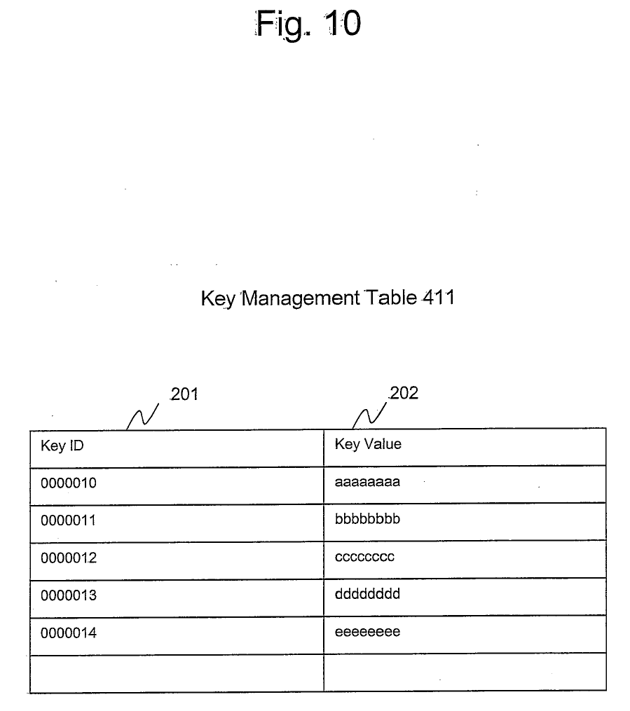

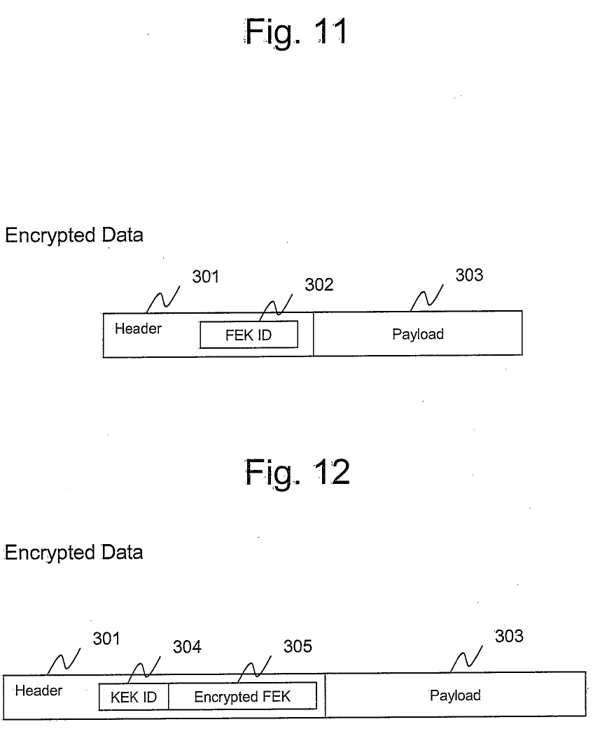

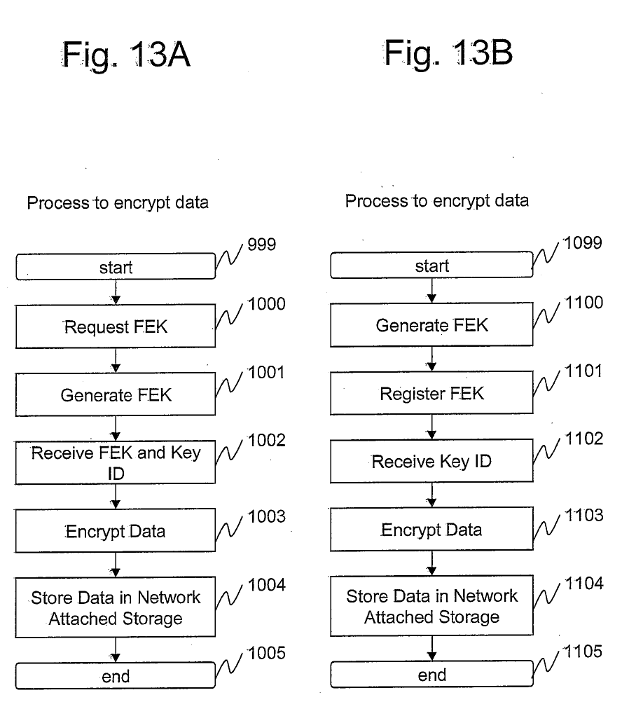

FIG. 10 shows an exemplary key management table according to aspects of the invention. FIG. 11 and FIG. 12 show two exemplary structures for encrypted data according to aspects of the invention.

The data structure of the encrypted data is described with respect to FIG. 10, FIG. 11 and FIG. 12. FIG. 10 shows one exemplary embodiment of the key management table 411 of FIG. 5. FIG. 11 and FIG. 12 show two types of encrypted data that may be used for the encrypted data 131 stored in the archive storage 1 or the encrypted data 231 stored in the network attached storage 2.

The key management table shown in FIG. 10 includes a key ID 201 and a key value 202 column. The key ID 201 indicates a unique identification for each encryption key. The key value 202 indicates the value of each encryption key.

The encrypted data 131, 231 may have various types of formats. Two exemplary formats are shown in FIG. 11 and FIG. 12.

FIG. 11 shows an encrypted file structure for encrypted data including a header 301 and payload of encrypted data 303. The header 301 includes an encryption key ID 302. This exemplary file structure contains the payload 303, including the encrypted data, and the identification of the encryption key 302 used for encrypting the encrypted data in the payload 303. The encryption key 302 is usually referred to as a file encryption key (FEK) or a data encryption key (DEK). A FEK is not included in the encrypted data 131 and 231, so the security module program 111 and the security module program 511 need to retrieve a FEK from the key management service program 410.

On the other hand, FIG. 12 shows an encrypted file structure including the header 301 and the payload 303, including the encrypted data, where the header 301 includes an encryption key ID 304 and an encrypted key 305. This exemplary file structure shows an example of a data structure that already includes the FEK itself and not just the ID of the FEK. For security reason, the FEK is usually included in encrypted format. An encryption key that is used for encrypting the file encryption key, FEK, is referred to as a key encryption key (KEK). Therefore, the security module program 111 and the security module program 511 need to retrieve the KEK for the encrypted FEK from the key management service program 410.

The header 301 contains information that is necessary to properly handle the data 303.

The FEK ID 302 contains the unique identification information of the FEK used for the data 303. In the exemplary embodiment of FIG. 1, the file encryption program 311, 711, 810 receives the FEK ID 302 information from the key management service program 410 and stores it in this field. On the other hand, the security-module program 111 and the security module program 511 refer to this field and request a FEK from the key management service program 410 that corresponds to the FEK ID 302.

The data 303 contains the encrypted data. The data is encrypted by the file encryption program 311, 711, 810 using an FEK that corresponds to the FEK ID 302.

The KEK ID 304 contains the unique identification information of a KEK used for encrypting the encrypted FEK 305. In the exemplary embodiment shown in FIG. 1, the file encryption program 311, 711, 810 receives the KEK ID 304 information from the key management service program 410 and stores the information in this field. On the other hand, the security module program 111 and the security module program 511 refer to this field 304 and request a KEK that corresponds to the KEK ID 304 from the key management service program 410 to receive the KEK

The encrypted FEK 305 contains an encrypted FEK for the encrypted data 303. To decrypt the data 303, the security module program 111 and the security module program 511 have to first decrypt the encrypted FEK 305 using a KEK that corresponds to the KEK ID 304.

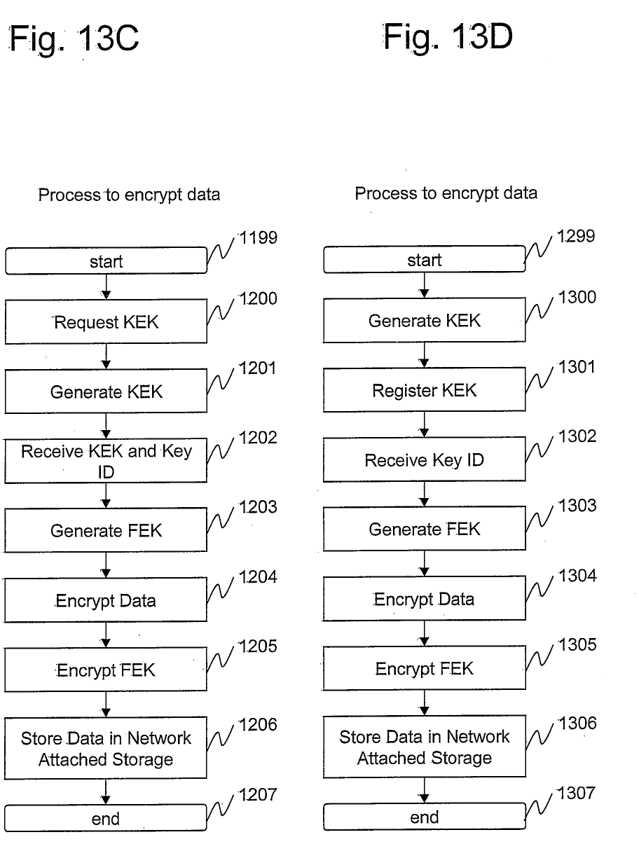

FIG. 13A, FIG. 13B, FIG. 13C and FIG. 13D show four exemplary methods of encrypting data according to aspects of the present invention.

These figures show four exemplary methods or processes for data encryption that are executed by the file encryption program 311, 711, 810, the key management service program 410, mail client program 710 and the network filesystem client program 312, 811. These methods indicate that the encryption key may be found or generated at a number of locations within the data storage system of FIG. 1.

FIG. 13A shows an exemplary encryption process where the file encryption program 311, 711, 810, at the host or client computers, receives the FEK from the key management service program 410. The file encryption program may reside at the mail server host computer 3 or at the mail client 8 or the encryption client 9.

The process begins at 999.

At 1000, the file encryption program sends a request for a FEK to the key management service program 410.

At 1001, the key management service program 410 generates a FEK and assigns a unique identification to the FEK. Then, the key management service program 410 stores the FEK identification in the key ID 201 field and the value of the FEK in key value 202 field of the key management table 411.

At 1002, the file encryption program receives the FEK and the identification information of the FEK from the key management service program 410.

At 1003, the file encryption program encrypts the data using the FEK that it has received from the key management service program 410 at 1002. Then, the file encryption program stores the identification information of the FEK in FEK ID 302 field.

At 1004, the network filesystem client program stores the encrypted data in the network attached storage 2. The mail client program skips this step. For example, the network filesystem client program 312 of the mail server host 3 or the network filesystem client program 811 of the encryption client 9 store the encrypted data in the network attached storage 2 but the mail client program 710 of the mail client 8 skips this step.

At 1005, the process of data encryption ends.

FIG. 13B shows an exemplary encryption process where the file encryption program 311, 711, 810, at the host computer or the client computer, generates the FEK and registers it on the key management service program 410.

The process beings at 1099.

At 1100, the file encryption program generates an FEK.

At 1101, the file encryption program sends a request for registering the FEK to the key management service program 410. The key management service program 410 assigns a unique identification information to the FEK. Then, the key management service program 410 stores the identification information in the key ID 201 field and stores the value of the FEK in the key value 202 field of the key management table 411.

At 1102, the file encryption program receives the identification information of the FEK from the key management service program 410.

At 1103, the file encryption program encrypts the data using the FEK that it has generated in step 1100 and has registered on the key management service program 410 in step 1101. Then, the file encryption program stores the identification information of the FEK in FEK ID 302 field.

At 1104 similar to 1004, the network filesystem client program stores the encrypted data in the network attached storage 2. The mail client program skips this step. For example, the mail server host 4 and the encryption client 9 that include network filesystem client programs 313, 811 perform the step but the mail client program 711 of the mail client 8 skips the step.

At 1105, the process of data encryption ends.

FIG. 13C shows an exemplary encryption process where the file encryption program 311, 711, 810 receives the KEK from the key management service program 410 and generates the FEK.

The process begins at 1299.

At 1200, the file encryption program sends a request for a KEK to the key management service program 410.

At 1201, the key management service program 410 generates a KEK and assigns a unique identification information to the KEK. Then, the key management service program 410 stores the identification information in the key ID 201 field and stores the value of the KEK in the key value 202 field of the key management table 411.

At 1202, the file encryption program receives the KEK and the identification information of the KEK from the key management service program 410.

At 1203, the file encryption program generates a FEK.

At 1204, the file encryption program encrypts the data using the FEK that it generated in step 1203.

At 1205, the file encryption program encrypts the FEK using the KEK that it received from the key management service program 410 in step 1202. Then, the file encryption program stores the identification information of the KEK in the KEK ID 304 field and stores the value of encrypted FEK in the encrypted FEK 305 field of the key management table 411.

At 1206 similar to 1004, the network filesystem client program stores the encrypted data in the network attached storage 2. The mail client program skips this step.

At 1207, the process of data encryption ends.

FIG. 13D shows an exemplary encryption process where the file encryption program 311, 711, 810 generates the KEK and registers it on the key management service program 410 and generates the FEK.

The process begins at 1299.

At 1300, the file encryption program generates a KEK.

At 1301, the file encryption program sends a request for registering the KEK to the key management service program 410. The key management service program 410 assigns a unique identification information to the KEK. Then, the key management service program 410 stores the identification information in the key ID 201 field and stores the value of the KEK in the key value 202 field of the key management table 411.

At 1302, the file encryption program receives the identification information of the KEK from key management service program 410.

After 1302, the process of FIG. 13D is similar to the process of FIG. 113C such that it continues with generating the FEK at 1303, encrypting the data using the generated FEK at 1304, encrypting the FEK using the KEK at 1305, storing the data in the network attached storage 2 at 1306. The mail client program skips step 1306 as well. The process ends at 1307.

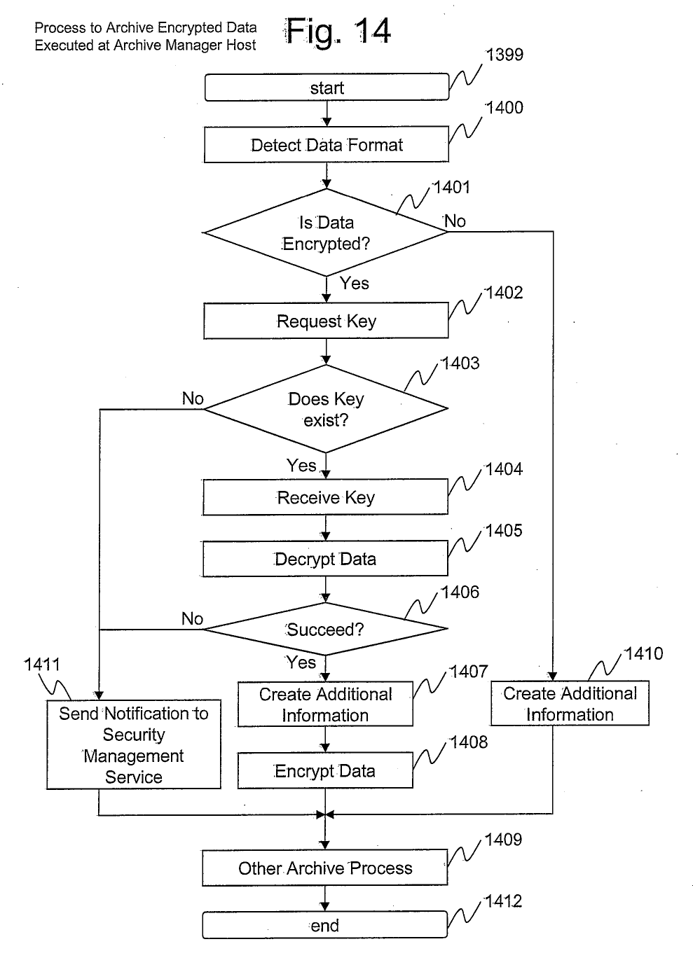

FIG. 14 shows an exemplary process for archiving encrypted data at a host computer, according to aspects of the invention.

FIG. 14 shows an exemplary process executed by the data archive application program 510 of the host computer 5 to archive the encrypted data.

The process beings at 1399.

At 1400, the data archive application program 510 determines a format of data that it has retrieved from the network attached storage 2.

At 1401, the process determines whether or not and if the data is not encrypted it then proceeds to step 1410, otherwise and for encrypted data, the process proceeds to step 1402.

At 1402, the data archive application program 510 invokes the security module program 511. The security module program 511 refers to the FEK ID 302 or the KEK ID 304 within the file header 301 of the encrypted data 231, and requests from the key management service program 410 the encryption key corresponding to the identification information. If the file header 301 of the encrypted data does not contain the encrypted FEK 305, the security module program 511 requests a FEK from the key management service program 410. If the file header 301 of the encrypted data contains the KEK ID 304 and the encrypted FEK 305, the security module program 511 requests a KEK from the key management service program 410.

At 1403, if the key management service program 410 has the FEK or the KEK corresponding to the requested identification information, then the method proceeds to step 1404, otherwise the method proceeds to step 1411.

At 1404, the security module program receives an encryption key from the key management service program 410. This encryption key is identified by the identification information provided by the security module program 511 in step 1402.

At 1405, if the file header 301 of the encrypted data does not contain an encrypted FEK 305, the security module program 511 decrypts the encrypted data 303 using the FEK that the security module program 511 received in step 1404. If the file header 301 of the encrypted data contains the encrypted FEK 305, the security module program 511 decrypts the encrypted FEK 305 using the KEK that the security module program 511 received in step 1404, and decrypts the encrypted data 303 using the decrypted FEK.

At 1406, if the security module program 511 has successfully decrypted the encrypted FEK 305 or the encrypted data 303, the method proceeds to step 1407 and otherwise, the method proceeds to step 1411.

At 1407, the data archive application program 510 creates some additional data such as meta data or search index information for the decrypted data. These search indices are used for finding particular portions of the data from among a large volume of archived or stored data.

At 1408, if necessary, the security module program 511 encrypts the data again according to the security policy of the organization owning the data.

At 1409, the data archive application program 510 performs other archiving processes. At 1413, the process ends.

If the data is determined not to be encrypted at 1401, the process moves to 1410. At 1410, the data archive application program 510 creates some form of meta data corresponding to the unencrypted data and process moves to 1.409 for other archiving processes before it ends at 1412.

If a decryption key is not found for the encrypted data at 1402, the process moves to 1411. At 1411, the security module program 511 sends a log to the security management service program 610 to notify a system administrator of the fact that there could be unauthorized encrypted data or data encrypted using an unauthorized key. The process then moves to 1409 for other archiving processes before it ends at 1412.

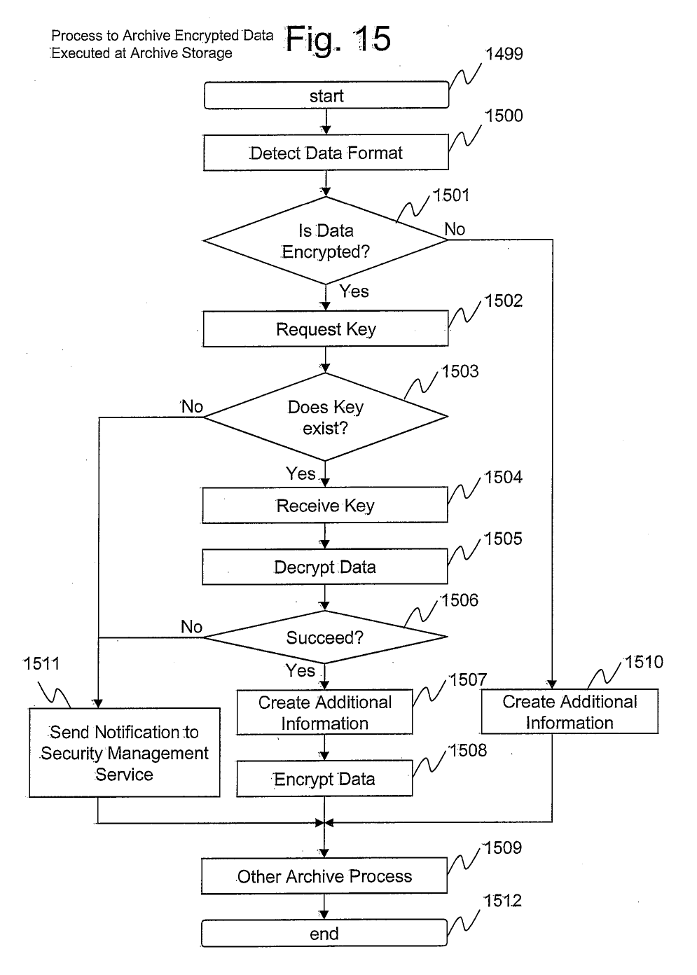

FIG. 15 shows an exemplary process for archiving encrypted data at the archive storage 1, according to aspects of the invention.

FIG. 15 shows an exemplary method executed by the data archive service program 110 of the archive storage 1 for archiving encrypted data. In FIG. 14, the data archive application program 510 of the archive manager host computer 5 detects the encryption status of data that it has retrieved from the network attached storage 2. On the other hand, in FIG. 15, the data archive service program 110 of the archive storage 1 detects the encryption status of data that it has received from the data archive application program 510 of the archive manager host computer 5.

The process begins at 1499.

At 1500, the data archive service program 110 looks at a format of data that it has received from the data archive application program 510, and then detects whether the data is encrypted or not.

At 1501, if the data is encrypted then the method proceeds to step 1502 and otherwise to step 1510.

At 1502, the data archive service program 110 invokes the security module program 111. The security module program 111 refers to the FEK ID or the KEK ID within the file header 301 of the encrypted data that the data archive service program 110 receives from the data archive application program 510, and request the encryption key corresponding to the identification information from the key management service program 410. If the file header 301 of the encrypted data does not contain an encrypted FEK 305, the security module program 111 requests a FEK from the key management service program 410. If the file header 301 of the encrypted data contains the KEK ID 304 and the encrypted FEK 305, the security module program 111 requests the KEK from the key management service program 410.

At 1503, if the key management service program 410 has the FEK or KEK corresponding to the requested identification information, then the method proceeds to step 1504 and otherwise to step 1511.

At 1504, the security module program receives an encryption key that is identified by the identification information security module program 111 and requested in step 1402 from the key management service program 410.

At 1505, if the file header 301 of the encrypted data does not contain the encrypted FEK 305, the security module program 111 decrypts the encrypted data 303 using the FEK that security module program 111 received in step 1504. If the file header 301 of the encrypted data contains the encrypted FEK 305, the security module program 111 decrypts the encrypted FEK 305 using the KEK that the security module program 111 received in step 1504, and decrypts the encrypted data 303 using the decrypted FEK.

At 1506, if the security module program 111 has successfully decrypted the encrypted FEK 305 or the encrypted data 303, the method proceeds to step 1507 and otherwise to step 1511.

At 1507, the data archive service program 110 creates some additional information such as meta data or search index information for the decrypted data.

At 1508, if necessary, the security module program 111 encrypts the data again according to a security policy.

At 1509, the data archive service program 110 performs other archiving processes.

The process ends at 1512.

If the data received is determined not be encrypted at 1501, the process proceeds to 1510. At 1510, the data archive service program 110 creates some meta data including search index information. The method then proceeds to 1509 for further archiving processes and ends at 1512.

If a decryption key is not found for the encrypted data at 1503, the process proceeds to 1511. At 1511, the security module program 111 sends a log to the security management service program 610 to notify a system administrator of the fact that there could be unauthorized encrypted data or data encrypted using an unauthorized key. The method proceeds to 1509 for further archiving processes and ends at 1512.

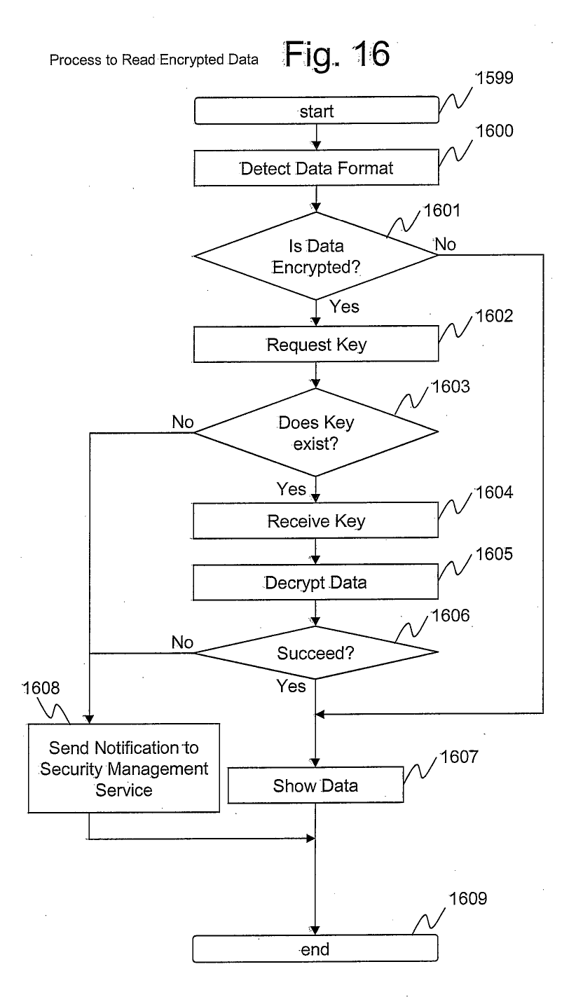

FIG. 16 shows an exemplary process for reading encrypted data at a host computer, according to aspects of the invention.

FIG. 16 shows an exemplary process executed by the security management service program 610, for reading the encrypted data at the security manager host computer 6.

The process begins at 1599.

At 1600, the security management service program 610 looks at a format of data that it has retrieved from the archive storage 1, and detects the format.

At 1601, it is determined whether data is encrypted or not. If the data is encrypted then the method proceeds to step 1602 and otherwise to step 1607.

At 1602, the security management service program 610 invokes the security module program 611 to request for a key for the encrypted data. The security module program 611 refers to the FEK ID or the KEK ID within the file header 301 of the encrypted data 131, and requests from the key management service program 410 for the encryption key corresponding to the identification information. If the file header 301 of the encrypted data does not contain the encrypted FEK 305, the security module program 611 requests the key management service program 410 for a FEK. If the file header 301 of the encrypted data contains the KEK ID 304 and the encrypted FEK 305, the security module program 611 requests the key management service program 410 for a KEK.

At 1603, if the key management service program 410 has the FEK or the KEK corresponding to the requested identification information, then the method proceeds to step 1604 and otherwise to step 1608.

At 1604, the security module program receives from the key management service program 410 an encryption key that is identified by the identification information security module program 611 and requested in step 1602.

At 1605, if the file header 301 of the encrypted data does not contain an encrypted FEK 305, the security module program 511 decrypts the encrypted data 303 using the FEK that the security module program 611 received in step 1604. If the file header 301 of the encrypted data contains the encrypted FEK 305, the security module program 611 decrypts the encrypted FEK 305 using the KEK that the security module program 611 received in step 1604, and decrypts the encrypted data 303 using the decrypted FEK.

At 1606, if the security module program 611 is successful in decrypting the encrypted FEK 305 or the encrypted data 303, the method proceeds to step 1607 and otherwise to step 1608.

At 1607, the security management service program 610 shows the decrypted data to an administrator and the method ends at 1609.

If a key is not found at 1603, the method arrives at 1608. At 1608, the security module program 611 sends a log to the security management service program 610 to notify a system administrator of the fact that there could be an unauthorized encrypted data or data encrypted using an unauthorized key. The method then ends at 1609.

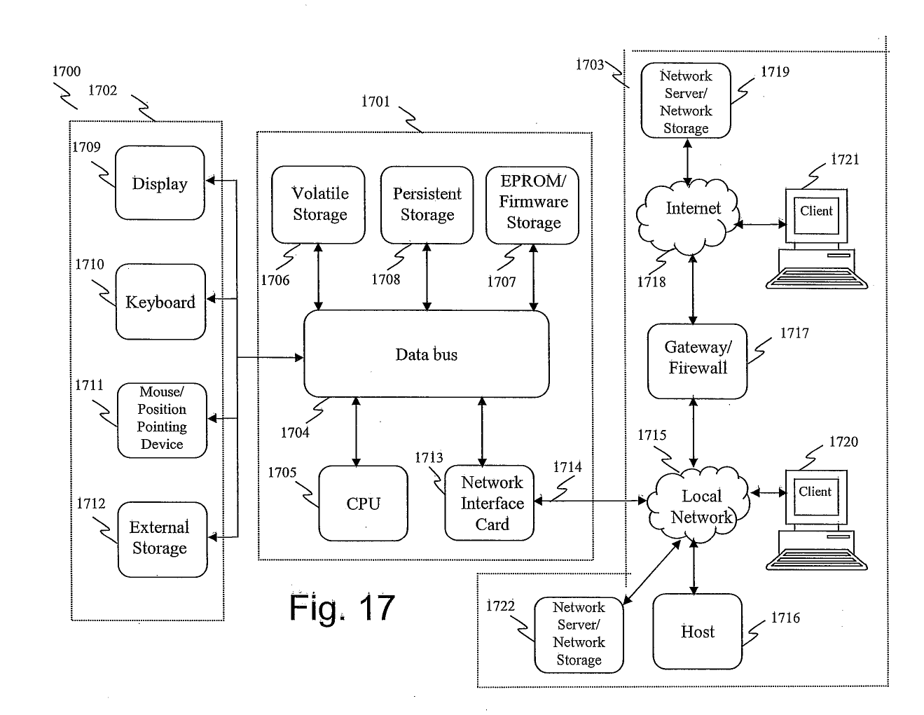

FIG. 17 is a block diagram that illustrates an embodiment of a computer/server system 1700 upon which an embodiment of the inventive methodology may be implemented. The system 1700 includes a computer/server platform 1701, peripheral devices 1702 and network resources 1703.

The computer platform 1701 may include a data bus 1704 or other communication mechanism for communicating information across and among various parts of the computer platform 1701, and a processor 1705 coupled with bus 1701 for processing information and performing other computational and control tasks. Computer platform 1701 also includes a volatile storage 1706, such as a random access memory (RAM) or other dynamic storage device, coupled to bus 1704 for storing various information as well as instructions to be executed by processor 1705. The volatile storage 1706 also may be used for storing temporary variables or other intermediate information during execution of instructions by processor 1705. Computer platform 1701 may further include a read only memory (ROM or EPROM) 1707 or other static storage device coupled to bus 1704 for storing static information and instructions for processor 1705, such as basic input-output system (BIOS), as well as various system configuration parameters. A persistent storage device 1708, such as a magnetic disk, optical disk, or solid-state flash memory device is provided and coupled to bus 1701 for storing information and instructions.

Computer platform 1701 may be coupled via bus 1704 to a display 1709, such as a cathode ray tube (CRT), plasma display, or a liquid crystal display (LCD), for displaying information to a system administrator or user of the computer platform 1701. An input device 1710, including alphanumeric and other keys, is coupled to bus 1701 for communicating information and command selections to processor 1705. Another type of user input device is cursor control device 1711, such as a mouse, a trackball, or cursor direction keys for communicating direction information and command selections to processor 1704 and for controlling cursor movement on display 1709. This input device typically has two degrees of freedom in two axes, a first axis (e.g., x) and a second axis (e.g., y), that allows the device to specify positions in a plane.

An external storage device 1712 may be connected to the computer platform 1701 via bus 1704 to provide an extra or removable storage capacity for the computer platform 1701. In an embodiment of the computer system 1700, the external removable storage device 1712 may be used to facilitate exchange of data with other computer systems.

The invention is related to the use of computer system 1700 for implementing the techniques described herein. In an embodiment, the inventive system may reside on a machine such as computer platform 1701. According to one embodiment of the invention, the techniques described herein are performed by computer system 1700 in response to processor 1705 executing one or more sequences of one or more instructions contained in the volatile memory 1706. Such instructions may be read into volatile memory 1706 from another computer readable medium, such as persistent storage device 1708. Execution of the sequences of instructions contained in the volatile memory 1706 causes processor 1705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1705 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1708. Volatile media includes dynamic memory, such as volatile storage 1706. Transmission media includes coaxial cables, copper wire and fiber optics, including the wires that comprise data bus 1704. Transmission media may also take the from of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer may read.

Various forms of computer readable media may be involved in carrying one or more sequences of one or more instructions to processor 1705 for execution. For example, the instructions may initially be carried on a magnetic disk from a remote computer. Alternatively, a remote computer may load the instructions into its dynamic memory and send the instructions over a telephone line using a modem. A modem local to computer system 1700 may receive the data on the telephone line and use an infra-red transmitter to convert the data to an infra red signal. An infra-red detector may receive the data carried in the infra-red signal and appropriate circuitry may place the data on the data bus 1704. The bus 1704 carries the data to the volatile storage 1706, from which processor 1705 retrieves and executes the instructions. The instructions received by the volatile memory 1706 may optionally be stored on persistent storage device 1708 either before or after execution by processor 1705. The instructions may also be downloaded into the computer platform 1701 via Internet using a variety of network data communication protocols well known in the art.

The computer platform 1701 also includes a communication interface, such as network interface card 1713 coupled to the data bus 1704. Communication interface 1713 provides a two-way data communication coupling to a network link 1714 that is connected to a local network 1715. For example, communication interface 1713 may be an integrated services digital network (ISDN) card or a modem to provide a data communication connection to a corresponding type of telephone line. As another example, communication interface 1713 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1713 sends and receives electrical, electromagnetic or optical signals that carry digital data streams representing various types of information.

Network link 1713 typically provides data communication through one or more networks to other network resources. For example, network link 1714 may provide a connection through local network 1715 to a host computer 1716, or a network storage/server 1722. Additionally or alternatively, the network link 1713 may connect through gateway/firewall 1717 to the wide-area or global network 1718, such as an Internet. Thus, the computer platform 1701 may access network resources located anywhere on the Internet 1718, such as a remote network storage/server 1719. On the other hand, the computer platform 1701 may also be accessed by clients located anywhere on the local area network 1715 and/or the Internet 1718. The network clients 1720 and 1721 may themselves be implemented based on the computer platform similar to the platform 1701.

Local network ˜1715 and the Internet 1718 both use electrical, electromagnetic or optical signals that carry digital data streams. The signals through the various networks and the signals on network link 1714 and through communication interface 1713, which carry the digital data to and from computer platform 1701, are exemplary forms of carrier waves transporting the information.

Computer platform 1701 may send messages and receive data, including program code, through the variety of network(s) including Internet 1718 and LAN 1715, network link 1714 and communication interface 1713. In the Internet example, when the system 1701 acts as a network server, it might transmit a requested code or data for an application program running on client(s) 1720 and/or 1721 through Internet 1718, gateway/firewall 1717, local area network 1715 and communication interface 1713. Similarly, it may receive code from other network resources.

The received code may be executed by processor 1705 as it is received, and/or stored in persistent or volatile storage devices 1708 and 1706, respectively, or other non-volatile storage for later execution. In this manner, computer system 1701 may obtain application code in the from of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data archiving capability. It is intended that the specification and examples be considered as exemplary only, with a true scope and spirit of the invention being indicated by the following claims and their equivalents.

What is claimed is:

1. A computerized data storage system comprising:
an encryption key management module operable to manage a plurality of encryption keys; and
an archive storage comprising one or more interconnect interfaces operable to couple the archive storage with the encryption key management module and one or more entities,
wherein the archive storage is operable to receive data including encrypted data from the one or more entities and archive the received data as archived data, and
wherein, in response to receipt of the encrypted data, the archive storage is operable to retrieve an encryption key from the encryption key management module, to decrypt the received encrypted data using the retrieved encryption key, provide one or more search indices or metadata for decrypted data and re-encrypt the decrypted data before archiving re-encrypted data.

2. The computerized data storage system of claim 1, wherein the one or more entities comprise an encryption module operable to generate the encrypted data using the encryption key and register the encryption key with the encryption key management module.

3. The computerized data storage system of claim 2,
wherein the one or more entities comprise one or more host computers coupled to the one or more interconnect interfaces, or one or more client computers coupled to the one or more interconnect interfaces, or both,
wherein functionalities of a mail server, an encryption key management module, an archive manager and a security manager are included in a same one of the host computers or distributed between different ones of the host computers, and
wherein functionalities of a mail client and an encryption client are included in a same one of the client computers or distributed between different ones of the client computers.

4. The computerized storage system of claim 3, wherein the archive storage further comprises:
a data archive service module for receiving the data at the archive storage;
a security module; and
the archived data,
wherein the data archive service module is adapted for:
communicating with a data archive application module of the archive manager, a key management service module of the key manager and a security management service module of the security manager,
providing an interface for the data archive application module for archiving the data in the archive storage, and
creating the search indices or metadata for the data, and
wherein the security module is adapted for:
being invoked by the data archive service module when the data received at the archive storage includes the encrypted data,
receiving an encryption key from the encryption key management module for the encrypted data,
decrypting the encrypted data for the data archive service module,
re-encrypting the data after decrypting the encrypted data, and
sending a notification to the security management service module, if no encryption key is provided for the encrypted data.

5. The computerized storage system of claim 3, further comprising:
a network attached storage being coupled to the one or more interconnect interfaces, wherein the network attached storage includes:
a network filesystem service module; and
stored data including encrypted stored data,
wherein the network filesystem service module is adapted for providing an interface for receiving the data from a mail service module of the mail server, and a network filesystem client module of the encryption client.

6. The computerized storage system of claim 3, wherein the one or more computers performing the mail server function comprises:
a mail service module;
a file encryption module; and
a network filesystem client module,
wherein the mail service module is adapted for sending the data to the mail client,
wherein the file encryption module is adapted for encrypting the data before the sending,
wherein the network filesystem client module is adapted for storing the data in the network attached storage, and
wherein the file encryption module is operable to use an encryption key from a key management service module of the key manager or generated by the file encryption module.

7. The computerized storage system of claim 3, wherein the computer performing the key manager function further comprises:
a key management service module; and
a key management table,
wherein the key management service module is adapted for generating or receiving encryption keys, and assigning a unique encryption key identification to each of the encryption keys, and
wherein the key management table is adapted for holding an encryption key value and the encryption key identification for each of the encryption keys.

8. The computerized storage system of claim 3, wherein the computer performing the archive manager function comprises:
a data archive application module; and
a security module,
wherein the data archive application module is adapted for:
retrieving a stored data from the network attached storage and archiving the stored data in the archive storage as the archived data,
creating the search indices or metadata for the archived data, and
invoking the security module for decryption if the stored data retrieved includes encrypted data, and
wherein the security module is adapted for:
communicating with a key management service module of the key manager and receiving an encryption key from the key management service module,
decrypting the encrypted data for the data archive application module,
re-encrypting the decrypted data after the data archive application module creates the search indices or metadata for the decrypted data, and
sending a notification to a security management service module of the security manager when an encryption key is not found.

9. The computerized storage system of claim 3, wherein the computer performing the security manager function comprises:
a security management service module; and
a security module,
wherein the security management service module is adapted for:
receiving notification from a data archive application module of the archive manager or a data archive service module of the archive storage regarding a an attempt to read encrypted data, and
providing a user interface to an administrator, and
wherein the security module is adapted for:
being invoked when the security management service module responsive to the attempt to read encrypted data,
communicating with a key management service module of the key manager and receiving an encryption key from the key management service module, and
sending a notification to the security management service module if no key is found.

10. The computerized storage system of claim 3, wherein the computer performing the mail client function comprises:
a file encryption module; and
a mail client module,
wherein the file encryption module is adapted for communicating with a key management service module of the key manager and a security management service module of the security manager, and
wherein the mail client module is adapted for communicating with a mail service module of the mail server and sending or receiving the data to the mail server.

11. The computerized storage system of claim 3, wherein the computer performing the encryption client function comprises:
a file encryption module; and
a network filesystem client module,
wherein the file encryption module is adapted for communicating with a key management service module of the key manager and a security management service module of the security manager, and
wherein the network filesystem client module is adapted for storing the data in the network attached storage through a network filesystem service module of the network attached storage.

12. A computerized data storage system comprising:
an encryption key management module operable to manage a plurality of encryption keys;
an archive module operatively coupled with the encryption key management module and one or more entities, the archive module being operable to receive data including encrypted data from the one or more entities and cause the received data to be archived as archived data; and
an archive storage operatively coupled with archive module and operable to store the archived data,
wherein, in response to receipt of the encrypted data, the archive module is operable to retrieve an encryption key from the encryption key management module, to decrypt the received encrypted data using the retrieved encryption key, provide one or more search indices or metadata for decrypted data and re-encrypt the decrypted data before causing the re-encrypted data to be archived in the archive storage.

13. The computerized data storage system of claim 12, wherein the one or more entities comprise an encryption module operable to generate the encrypted data using the encryption key and register the encryption key with the encryption key management module.

14. The computerized data storage system of claim 13, wherein the one or more entities comprise at least one host computer or at least one client computer.

15. A computer-implemented method comprising:
managing a plurality of encryption keys;
receiving data including encrypted data from one or more entities, the encrypted data having been encrypted with one or more of the plurality of encryption keys;
in response to receipt of the encrypted data, retrieving an encryption key from the managed plurality of encryption keys;
decrypting the received encrypted data using the retrieved encryption key;
providing one or more search indices or metadata for decrypted data;
re-encrypting the decrypted data; and
causing the re-encrypted data to be archived in an archive storage system.

16. The computer-implemented method of claim 15, wherein the retrieving and decrypting is performed by the archive storage system.

17. The computer-implemented method of claim 15, wherein the retrieving and decrypting is performed by an archive module separate from the archive storage system.

18. The computer-implemented method of claim 15, wherein the encrypted data includes a header and a payload and wherein the header includes a key identification for the encryption key used for encrypting the data in the payload, the method further comprising:
retrieving the encryption key from a key management table providing an encryption key value corresponding to each key identification.

19. The computer-implemented method of claim 15, wherein the encrypted data includes a header and a payload and wherein the header includes a key identification for a key encryption key and an encrypted encryption key, the key encryption key being used for encrypting the encryption key, the encryption key being used for encrypting the data in the payload, the method further comprising:
retrieving the key encryption key from a key management table providing an encryption key value corresponding to each key identification; and
decrypting the encrypted encryption key to obtain the encryption key.

20. The computer-implemented method of claim 15, wherein requesting the encryption key from a key management service module comprises:
sending a request for the encryption key to the key management service module;
generating the encryption key at the key management service module and assigning a unique key identification to the encryption key;
storing the encryption key identification in a key identification field of a key management table and storing a value of the encryption key in a key value field of the key management table; and
providing the encryption key for decrypting the encrypted data.

21. The computer-implemented method of claim 15, further comprising:
generating the encryption key,

22. The computer-implemented method of claim 21, wherein requesting the encryption key from a key management service module comprises:
sending a request to the key management service module for registering the encryption key;
assigning a unique key identification to the encryption key at the key management service module;
storing the encryption key identification in a key identification field of a key management table and storing a value of the encryption key in a key value field of the key management table; and
providing the encryption key for decrypting the encrypted data.

23. A computer-implemented method for retrieving stored data, the method comprising:
retrieving data;
invoking a security module if the data includes encrypted data;
if a encryption key is not found within the encrypted data, requesting the encryption key from a key management service module;
decrypting the encrypted data using the encryption key;
creating search indices or metadata for decrypted data;
re-encrypting the data including the decrypted data; and
storing re-encrypted data and the search indices or metadata,
wherein the method is carried out at a host computer coupled to a storage system, and the data is retrieved from the storage system by the host computer, the host computer comprising an archive management functionality, and
wherein the key management service module is located at the host computer.

24. A computer-implemented method of claim 23, wherein the storage system further comprises a network attached storage or an archive storage.

25. A computer-implemented method for data storage, the method comprising:
receiving data;
invoking a security module if the data includes encrypted data;
if a encryption key is not found within the encrypted data, requesting the encryption key from a key management service module;
decrypting the encrypted data using the encryption key;
creating search indices or metadata for decrypted data;
re-encrypting the data including the decrypted data; and
storing re-encrypted data and the search indices or metadata,
wherein the method is carried out at an archive storage coupled to a host computer and the data is received by the archive storage from the host computer, the host computer including archive management functionalities, and
wherein the key management service module is located at the host computer.

26. A computer-readable medium embodying one or more sequences of instructions, which, when executed by one or more processors, causes the one or more processors to perform a method comprising:
managing a plurality of encryption keys;
receiving data including encrypted data from one or more entities, the encrypted data having been encrypted with one or more of the plurality of encryption keys;
in response to receipt of the encrypted data, retrieving an encryption key from the managed plurality of encryption keys;
decrypting the received encrypted data using the retrieved encryption key;
providing one or more search indices or metadata for decrypted data;
re-encrypting the decrypted data; and
causing the re-encrypted data to be archived.

27. The computer-readable medium of claim 26, wherein the retrieving and decrypting is performed by the archive storage system.

28. The computer-readable medium of claim 26, wherein the retrieving and decrypting is performed by an archive module separate from the archive storage system.
